(19) United States
(12) Patent Application Publication
(10) Pub. No.: US 2013/0054422 A1
(43) Pub. Date: Feb. 28, 2013

(54) Location And Event-Based Mobile Commerce Method And System

(71) Applicants: Michael DeSouza, Scarborough, ME (US); Charles Goldman, Hingham, MA (US); Matthew Wogan, Freeport, ME (US)

(72) Inventors: Michael DeSouza, Scarborough, ME (US); Charles Goldman, Hingham, MA (US); Matthew Wogan, Freeport, ME (US)

(21) Appl. No.: 13/220,160

(22) Filed: Aug. 29, 2011

(51) Int. Cl. G06Q 30/00

(52) U.S. Cl. 705/27.1

(57) ABSTRACT

The invention is a location and event-based mobile commerce system and method, wherein a geo-fence is placed around an event such as a concert or sporting event, and products and services tailored to that event and/or the event's location are offered to users that come inside the geo-fence, via an online/virtual store.

### 1. FIELD OF THE INVENTION

The invention is in the area of mobile commerce.

### 2. DESCRIPTION OF THE RELATED ART

The offering and selling of products and services to consumers through their mobile devices is known in the art. However, the prior art does not exhibit the features of the present invention—that is, putting a geo-fence around an event such as a concert or sports contest, and offering products and services tailored to that event and the event's location to users that come inside the geo-fence, via a virtual store.

U.S. Published Applications 2010/0217688 and 2010/0211481, both to Pandurangen, show examples of methods for offering and purchasing items online through a mobile computing apparatus. U.S. Pat. Nos. 6,983,202 to Sanqunetti and 7,493,211 to Breen are examples of geo-fencing. U.S. Pat. No. 6,731,940 to Nagendran discusses using wireless geo-location to customize the content and delivery of information to wireless communication devices. However, none of these disclose the features of the invention.

U.S. Pat. Nos. 6,317,718 to Fano and 7,200,566 to Moore disclose systems and methods for providing information including product and service offers to consumers based on their location. However, in these patents the consumer first sends a message asking about certain desired items, and also goes to the physical store to purchase them. Both of these aspects are very different from the invention, which involves a virtual store and does not involve the consumer asking first about certain desired items.

U.S. Pats./Published Appls. 2001/0049636 to Hudda; U.S. Pat. No. 7,027,801 to Hall; U.S. Pat. No. 7,672,280 to Shim; U.S. Pat. No. 6,647,269 to Hendrey; U.S. Pat. No. 6,208,866 to Roulhollahzadeh; U.S. Pat. No. 6,647,257 to Owensby; 2001/0053999 to Feinberg; and U.S. Pat. No. 6,091,956 to Hollenberg all disclose methods and systems for sending advertisements or other content to consumers located within a target area. But in each case, the consumer does not purchase something via a virtual store—instead, he is sent an advertisement and then makes the purchase at a physical store. Moreover, these prior art publications do not involve the consumer attending an “event” in the same way as the invention.

U.S. Pat. No. 7,813,741 to Hendrey discloses a system and method for initiating responses to location-based events. However, the focus of this patent is not on e-commerce or commerce at all, but rather toward improving the effectiveness of responses to emergency events such as an accident. Said another way, this patent involves location-based events, but in a very different way than the invention.

U.S. Pat. No. 7,869,816 to Merheb discloses a method of transmitting area-specific content to mobile devices. However, Merheb does not discuss a connection to an event occurring in the specific area, and also does not involve the consumer purchasing something via a virtual store.

### SUMMARY OF THE INVENTION

The invention is a location and event-based mobile commerce system and method, wherein a geo-fence is placed around an event such as a concert or sporting event, and products and services tailored to that event and/or the event's location are offered to users that come inside the geo-fence, via an online/virtual store.

The invention involves an event (for example, a sports contest, concert, or the like) that is taking place independent of the goods and/or services offered. Said another way, in the invention the event is not the offer of the goods and/or services itself. The invention is thus different and distinct from a system wherein the event is the offer or sale of goods and/or services itself, such as a sale on various items at a brick-and-mortar store, which items one can also purchase online.

### Several Objects and Advantages of the Invention are:

It is an object and advantage of the invention to provide a system and method that enables a user, while in proximity to an event, to purchase goods and/or services associated with that event online via a mobile device.

It is a further object and advantage of the invention to provide a system and method wherein offers in an online store can be associated with the event's physical location, and can also vary depending on the geographic location of the event.

It is a further object and advantage of the invention to provide a system and method wherein the user, once he has “unlocked” a given online store, can thereafter access that online store and purchase goods and/or services, whether or not the user is at that time in proximity to an event associated with the online store.

It is a further object and advantage of the invention to provide a system and method that can draw people to an event even if they had not previously known about the event or been interested in it.

It is a further object of the invention to provide a system and method wherein a user can share offers in an online store with other users of the system.

Further objects and advantages of the invention will become apparent from a consideration of the ensuing description and drawings.

### DESCRIPTION OF THE DRAWINGS

FIG. 1 illustrates the components of the inventive system and method, including the mobile device, server, and geo-fence aspect.

FIG. 2 shows two different scenarios for tracking the location of the user's mobile device, alerting the user to an event online store, and permitting access to the event online store.

FIG. 3 shows the invention's method for determining the goods and/or services offered in an online store, including the various inputs that can influence the determination.

FIG. 4 illustrates an alert screen, on the mobile device, for alerting a user to an event online store.

FIG. 5 shows an event-related offer.

FIG. 6 illustrates the screen that appears when the invention's application is launched.

FIG. 7 illustrates a more detailed map of a particular online store including information on how to unlock it.

FIG. 8 shows an alert screen notifying the user about an alternative method of unlocking an online store.

FIG. 9 shows another type of event-related offer.

FIG. 10 shows a purchase screen associated with the offer shown in FIG. 9.

FIG. 11 shows an edit screen to modify various parameters of the offer shown in FIG. 9.

FIG. 12 illustrates another purchase screen associated with the offer shown in FIG. 9, wherein payment and shipping information can be modified and the order confirmed.

FIG. 13 shows the user's account password being requested, in order to complete a purchase.

FIG. 14 illustrates a purchase screen associated with the offer shown in FIG. 5, wherein payment and shipping information can be modified and the order confirmed.

FIG. 15 shows the screen used for redeeming the offer shown in FIG. 5 at the associated establishment, after the user has purchased the offer.

FIG. 16 shows another redemption screen similar to that shown in FIG. 15, but with the code entered by a representative of the establishment.

FIG. 17 illustrates the screen which appears after the redemption code has been entered by a representative of the establishment, and which confirms the redemption.

FIG. 18 shows a screen enabling the user to share a particular offer with other users of the system.

FIG. 19 shows various options/avenues that are available for sharing an offer with other users.

FIG. 20 illustrates a login screen which may be required when using certain sharing options.

FIG. 21 shows a screen for posting comments that accompany the “share” of an offer with other users.

FIG. 22 shows an administration screen listing the current users of the system.

FIG. 23 shows an administration screen listing the various offers/deals available in the system.

FIG. 24 shows an administration screen containing detail on a particular offer/deal.

FIG. 25 shows an administration screen listing the various online stores present in the system.

FIG. 26 shows an administration screen containing detail on a particular online store.

FIG. 27 shows an administration screen listing the various events present in the system.

FIG. 28 shows an administration screen containing detail on a particular event.

FIG. 29 shows an administration screen listing the various locations present in the system.

FIG. 30 shows an administration screen containing detail on a particular location.

### DETAILED DESCRIPTION OF THE INVENTION

The following provides a list of the reference characters used in the drawings:
10. Geo-fence
11. Event
12. Mobile device
13. Query
14. Alert
15. Server
18. Map
19. Okay button
20. Offers
21. Online stores taskbar
22. Buy now button
23. Pagination dots
24. Item for purchase
25. Credit card information
26. Shipping information
27. Item cost
28. Select options button
29. Confirm order button
30. Password alert
31. Keypad
32. Code display area
33. Data communications network
34. Share button
35. Share methods
36. Login button
37. Share text display area
38. Share to (share service) button
39. Oregon State Beavers online store button
40. UCLA Bruins online store button
41. Fenway Park online store button
42. Locked indicator
43. Unlocked indicator
44. Detail map
45. Unlocking information
46. All stores button
47. Share notification
48. Ask friends button
49. Cancel button
50. User names
51. User email addresses
52. Delete button
53. Suspend button
54. Promote to admin button
55. Demote admin button
56. Offer name
57. Offer price
58. Deactivate button
59. Edit button
60. View button
61. Display all deals button
62. Online store name
63. Create a new store button
64. Create a new deal button
65. Add a deal button
66. View deals button
67. Add an event button
68. View events button
69. Activate button
70. Create a new event button
71. View on map button
72. Create a new location button

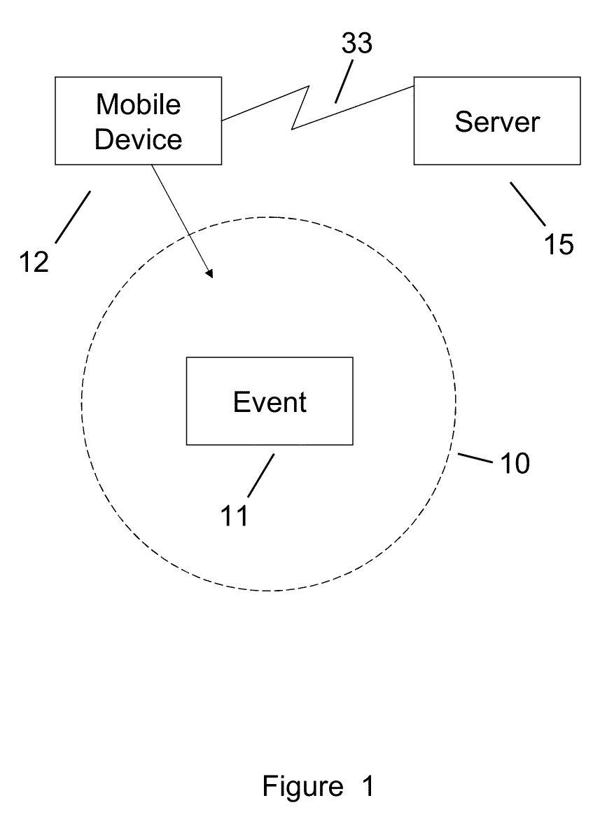

As seen in FIG. 1, the inventive system and method operates via a server 15 or another suitable computer connected to a wired or wireless data communication system 33, for example the Internet. FIG. 1 also illustrates the geo-fence aspect of the inventive system and method. Server 15 establishes a geo-fence 10 around the physical location of an event 11, for example a sporting event or concert. Although geo-fence 10 is shown as circular in FIG. 1, with a certain radius around event 11, the shape of geo-fence 10 can be square, rectangular, or another regular or irregular shape. The system can of course maintain geo-fences around multiple events at any given time.

Geo-fence 10 is established at a certain time associated with the start of event 11, within a certain geographic area associated with event 11, and for a certain duration associated with event 11. When a mobile device 12 comes inside geo-fence 10, the system sends a message to the user of mobile device 12. Mobile device 12 is, for example, a wireless mobile communications device carried by a user who has subscribed to the system and downloaded the associated mobile application, such as a cellular telephone, tablet, computer, or similar device, or a mobile device incorporated in the vehicle a user is traveling in. Mobile device 12 can communicate over the data communications system to which server 15 or the other suitable computer is connected—for example, it is an Internet-enabled “smart phone” such as the Apple® iPhone® or similar, which has the ability to download and run mobile applications such as those associated with the inventive system and method. Mobile device 12 also preferably includes a touch screen for interaction between the inventive system and the user, although other suitable forms of interaction are contemplated. The inventive system knows the location of mobile device 12 either by triangulating its location from the transmissions between mobile device 12 and various transmitter/receivers such as cellular telephone towers, or via a global positioning system (GPS) device incorporated into mobile device 12.

It should be understood that other suitable means can be used by the system to track the location of mobile device 12 or a plurality of such mobile devices. It can also be appreciated that there may be users with mobile devices who are already within geo-fence 10 when it is initially generated. Those users receive a message in the same manner as users who move from outside to inside geo-fence 10.

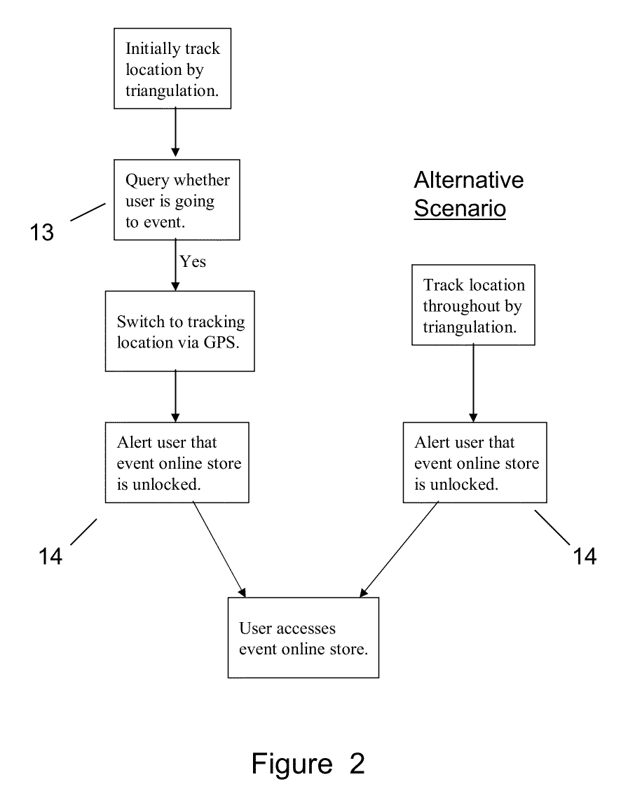

As shown in FIG. 2, the message can comprise a query 13 to the user regarding whether the user is going to event 11. In this embodiment, the system initially tracks the location of mobile device 12 by triangulating its location from the transmissions between mobile device 12 and various transmitter/receivers such as cellular telephone towers, and the system sends query 13 after detecting that mobile device 12 is within geo-fence 10. If the user replies “Yes” to query 13, indicating that the user is going to event 11, then the system switches to using GPS (if mobile device 12 is GPS-enabled) to track the location of mobile device 12 since GPS typically provides a more accurate location reading. The system also sends alert 14 to the user of mobile device 12, alerting the user that his location has unlocked (allowed access to) an online store associated with event 11. The user can then access the online store using the mobile commerce application that is discussed in greater detail below.

In an alternative embodiment, the system tracks the location of mobile device 12 throughout by triangulating its location from the transmissions between mobile device 12 and various transmitter/receivers such as cellular telephone towers. In this embodiment, the system skips query 13, and instead sends alert 14 directly after detecting that mobile device 12 is within geo-fence 10. As in the embodiment above, alert 14 alerts the user that his location has unlocked (allowed access to) an online store associated with event 11. The user can then access the online store using the mobile commerce application.

In either of the above embodiments, it can be appreciated that querying/alerting the user to event 11 is advantageous no matter whether the user had previously planned to attend event 11 or not. That is, even if the user had not previously planned to attend event 11, querying/alerting the user to the event may cause him to change his plans and attend the event. In other words, this can serve to draw people to an event even if they had not previously known about the event or been interested in it.

### Mobile Commerce Aspect of System and Method

The mobile commerce aspect of the invention is both event and location-based. That is, the online store or stores that are “unlocked” and thus available to the user are associated with the event that the user is in proximity to. As just one example, if the event in question is a sports event involving the Oregon State Beavers athletic team, then the online store can feature Oregon State athletic apparel and other merchandise, or services associated with the sports event or future sports events. The online store can also offer event-specific deals, such as discounts on food and drinks at a restaurant located at the event or in suitable proximity to the event. Similarly, if the event in question is a concert by a certain musical artist, then the online store can feature clothing with the artist's name or other artist-associated merchandise, or services like downloads of the artist's current hits.

In addition to being event-based, the online store is also location-based, in the sense that the offers in the online store are associated with the event's physical location (for example, discounts at a restaurant or bar near the event). Another location-based aspect is that the merchandise and services offered to the user in the online store can vary depending on the geographic location of the event. For example, hats with a sports team logo may be more popular at sports events in the Northeast part of the United States, while T-shirts are more popular at sporting events on the West Coast. Thus, sports hats can be emphasized in an online store associated with a sporting event in the Northeast, and sports T-shirts can be emphasized in an online store associated with a sporting event on the West Coast. As another example, clothing with a musical artist's name on it may be more popular at concerts in urban areas, while musical downloads are more popular at concerts in suburban areas. Thus, clothing can be emphasized in an online store associated with an urban musical concert, and downloads can be emphasized in an online store associated with a suburban musical concert.

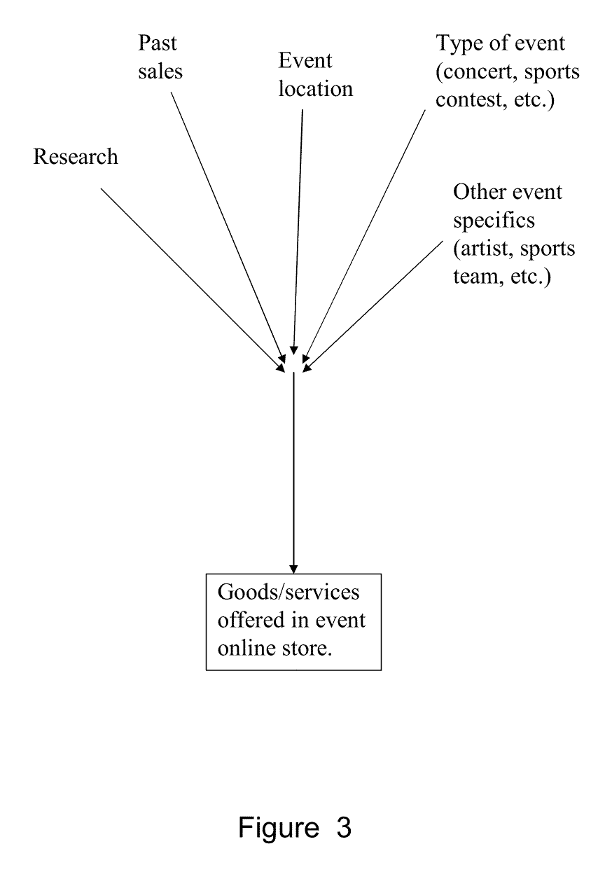

Further, the system uses various inputs to determine the goods and services that are offered in the online store which is “unlocked” for the user. As shown in FIG. 3, the system can use inputs such as research on user preferences, past sales of goods and services associated with similar events, the event location, the type of event (concert, sports contest, etc.), and other event specifics (the specific artist, specific sports teams involved, etc.) to determine the most attractive goods and services to be offered in the event online store.

In sum, with the inventive system and method, the goods and services offered in the event online store are tailored to the event, its location, and the demonstrated and/or estimated preferences of the user.

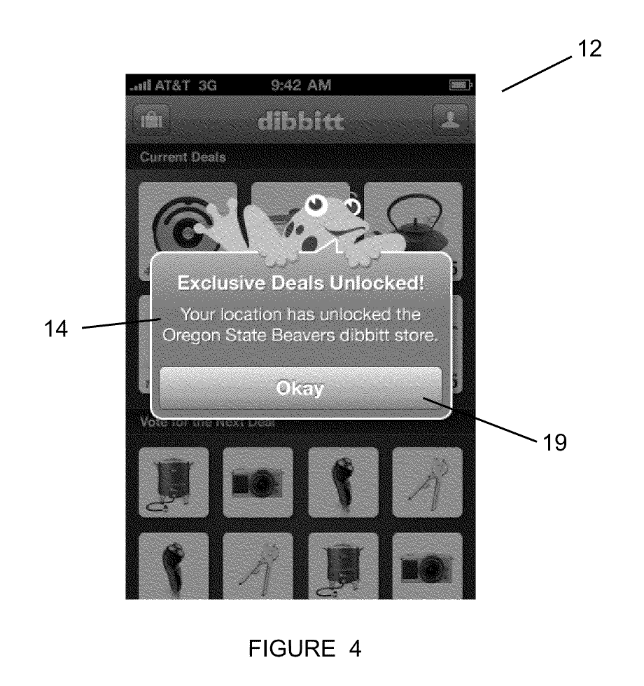

Returning now to the querying/alerting of the user when he is in proximity to the event, FIG. 4 shows an example of an alert 14 that is delivered by server 15, or another server associated with the system, to mobile device 12 when the user is within geo-fence 10 and has the screen of FIG. 4 showing on mobile device 12. The user acknowledges alert 14 by tapping on okay button 19.

It should be understood that FIG. 4 shows an alert 14 in the scenario where the invention's mobile commerce application is already operating on mobile device 12. Alert 14 can be shown on any screen in the mobile commerce application that is currently being presented to the user, not just the screen of FIG. 4. Moreover, the user can also be alerted when the invention's mobile commerce application is not operating on mobile device 12, for example by a generic message alerting the user to start the invention's mobile commerce application and discover the unlocked online store. Further, the user can opt-out of “push” notifications/alerts such as that shown in FIG. 4, and instead access the locked and unlocked online stores by launching the invention's mobile commerce application, as further discussed below.

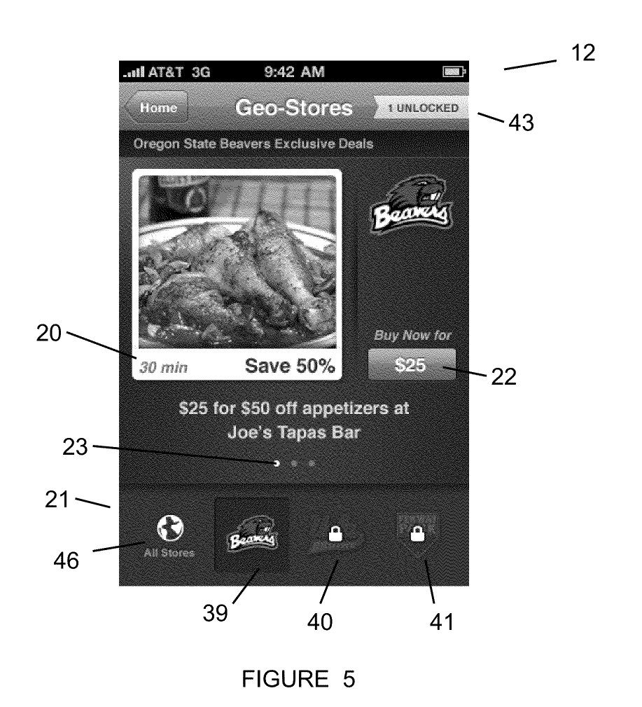

As shown in FIG. 5, after the user acknowledges alert 14, offers 20 tailored to the event and/or the event's location are delivered to mobile device 12 by server 15, or another server associated with the system. Multiple offers 20 specific to the event and/or location can be presented to the user, not just the single offer 20 shown in FIG. 5. Moreover, offers 20 specific to multiple events and/or multiple locations can be presented to the user—in other words, not just offers specific to a single event. In the scenario with multiple offers 20, the user can page through the other offers by any suitable method, for example by “swiping” at the screen of mobile device 12 to move the currently-displayed offer from the screen and display a different offer. Pagination dots 23 are displayed on the screen below the offers 20, to indicate where the currently-displayed is among the multiple offers and aid the user in navigating among multiple offers.

In another embodiment, the inventive system can display the offer screen shown in FIG. 5 to the user directly when mobile device 12 is inside geo-fence 10—i.e., without first displaying the alert 14 shown in FIG. 4.

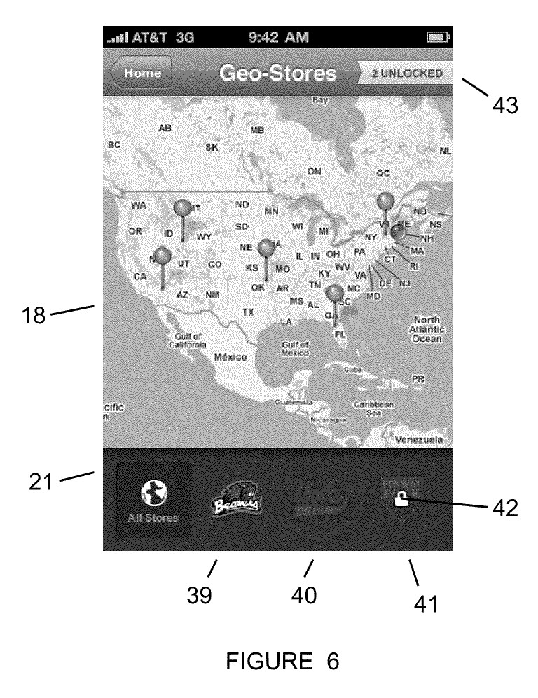

When the user launches the invention's mobile commerce application from mobile device 12 on his own initiative—for example, without being prompted by an alert 14 or without the system automatically launching the application when the user is inside a geo-fence—the screen shown in FIG. 6 is displayed to the user. This “all stores” screen includes a map 18 with push-pins showing the locations of online stores that the system is currently operating. Buttons with logos representing the current online stores are displayed in an online stores taskbar 21 at the bottom of the “all stores” screen. Here, the buttons are the Oregon State Beavers online store button 39, the UCLA Bruins online store button 40, and the Fenway Park online store button 41. Here also, Fenway Park online store button 41 includes a locked indicator 42 which means that the Fenway Park online store is currently locked to the user, so that the user cannot access it. In contrast, Oregon State Beavers online store button 39 and UCLA Bruins online store button 40 include no such locked indicator, meaning that those online stores are unlocked and accessible to the user. An unlocked counter 43 is also displayed on the FIG. 6 screen, and it corresponds to the number of online stores that are unlocked and accessible to the user—here, the Oregon State Beavers and UCLA Bruins online stores. It should be understood that online stores taskbar 21 can display more online store logo buttons than just the three shown in FIG. 6. The user can display the other online store buttons by swiping at online stores taskbar 21 to move the other online store buttons into view.

When the user taps on an unlocked online store button, the system displays the offer screen corresponding to that online store. For example, when the user taps on Oregon State Beavers online store button 39, the system displays the offer screen shown in FIG. 5.

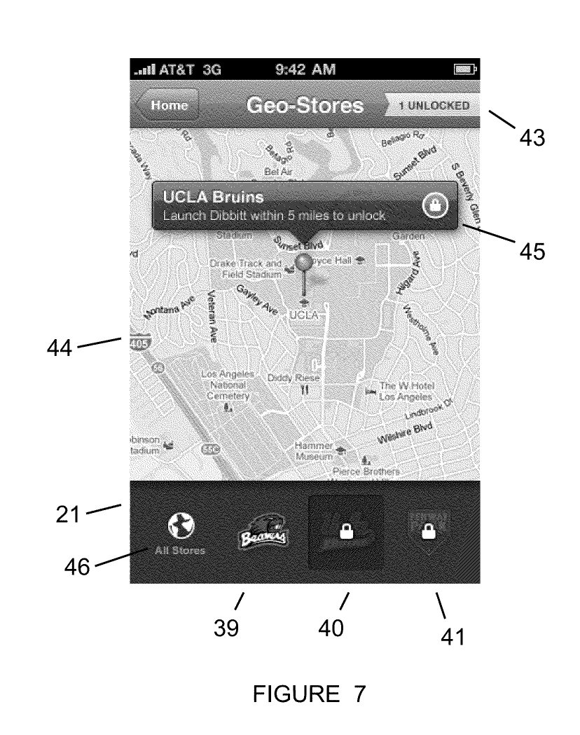

When the user taps on a locked online store button, the system displays the screen shown in FIG. 7. This screen displays a detail map 44 centered on the location of the locked online store—here, the UCLA Bruins online store—and also includes unlocking information 45 which tells the user how to unlock the store. Unlocking information can, for example, inform the user to unlock the online store by launching the invention's mobile commerce application within a given distance of a certain physical location. The given distance corresponds to the geo-fence 10 around the physical location. Said another way, if the user gets within the given distance, he is inside geo-fence 10 and the online store unlocks for him. To return to the “all stores” screen shown in FIG. 6, the user taps on the all stores button 46 in online stores taskbar 21.

It should be understood that FIGS. 6 and 7 are illustrative, and do not perfectly correspond in terms of online stores being locked or unlocked. For example, the “all stores” screen of FIG. 6 shows UCLA Bruins online store 40 as being unlocked, whereas in the “detail map” screen of FIG. 7 this online store is locked in order to illustrate the unlocking information.

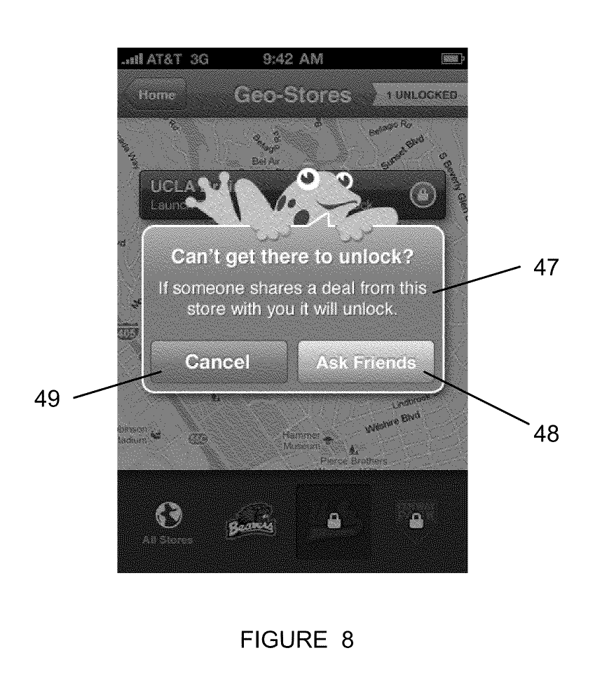

If the user cannot get within geo-fence 10 to unlock the online store, the system displays the share notification 47 shown in FIG. 8. That is, even if the user cannot get within the geo-fence of an online store he is interested in, the user can tap Ask friends button 48 to contact other users of the system. If another user who has access to the online store shares an offer from the online store with the first user, then the online store unlocks for the first user, permitting access. If the user is not interested in asking other users to share, he taps Cancel button 49 and share notification 47 disappears. Other procedures for sharing offers are discussed below.

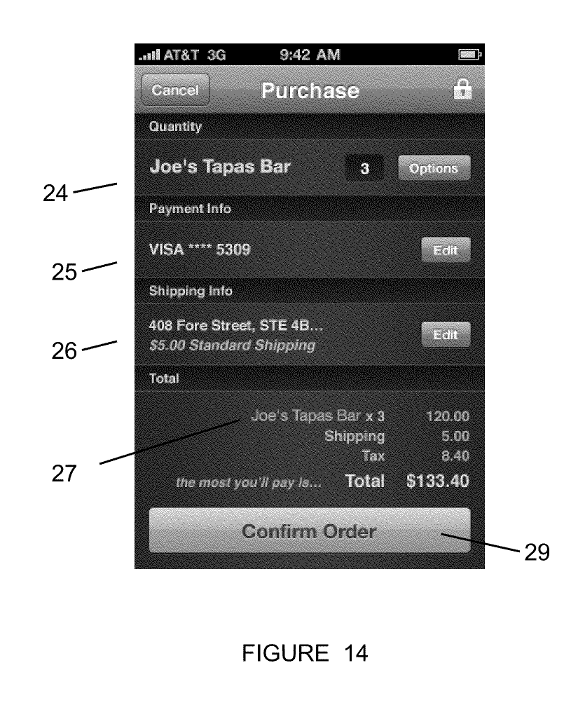

Returning now to the offer screen shown in FIG. 5, this screen also includes online stores taskbar 21, all stores button 46, buttons for the various online stores in the system, and unlocked counter 43. The screen shown in FIG. 5 further includes a Buy Now button 22 which shows the price for the currently-displayed offer 20. When the user taps on Buy Now button 22 in FIG. 5, the screen shown in FIG. 14 appears.

The screen shown in FIG. 14 displays Item for purchase 24, Credit card information 25, Shipping Information 26, and Item cost 27. The user reviews his order, and if the user wishes, her can modify the quantity of items purchased, access any options associated with the item, edit the credit card/payment information, and edit the shipping information. When the order is satisfactory, the user confirms the order by tapping on Confirm Order button 29.

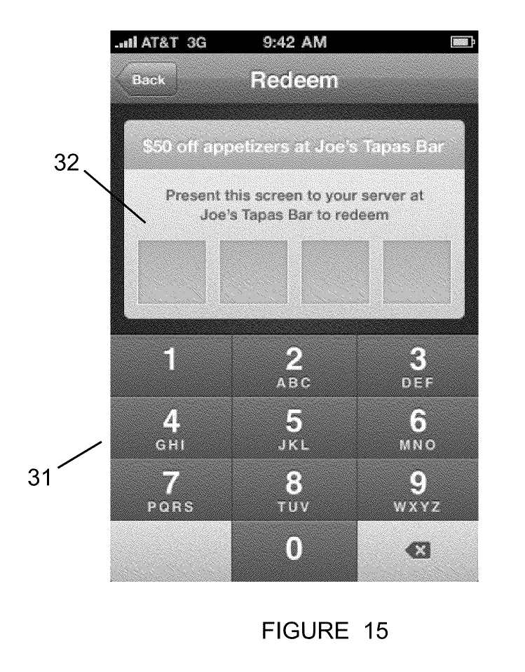

When the user decides to redeem an instant redemption purchase such as the one discussed above, he proceeds to the establishment to which the instant redemption purchase applies (for example, Joe's Tapas Bar). The user accesses the Redeem screen shown in FIG. 15, and presents mobile device 12 with the Redeem screen on it to a representative of the establishment such as a server or manager.

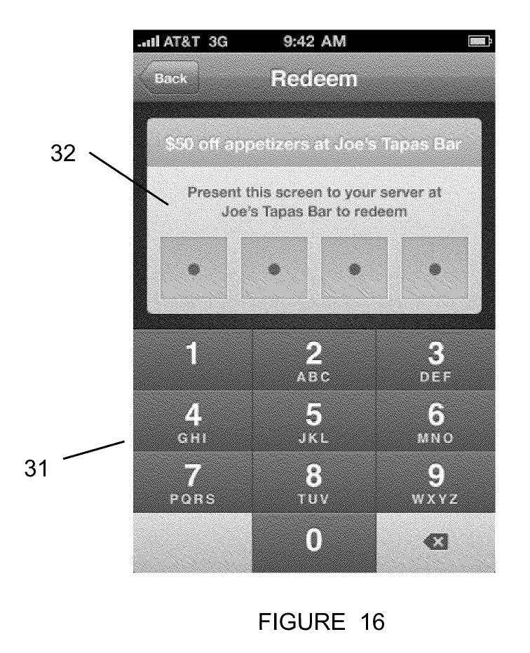

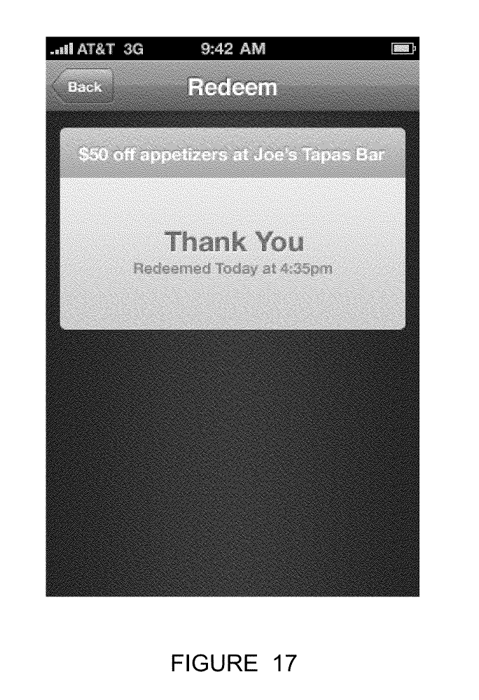

Using keypad 31, the representative types in a unique four digit code associated with the instant redemption purchase and known to the establishment. As shown in FIG. 16, dots representing the typed-in code appear in code display area 32, and when the correct four digit code is entered, the instant redemption offer is redeemed and the user receives, in this example, $50 off appetizers. The system then removes the instant redemption purchase from the system and mobile device 12, and displays the redemption confirmation screen shown in FIG. 17.

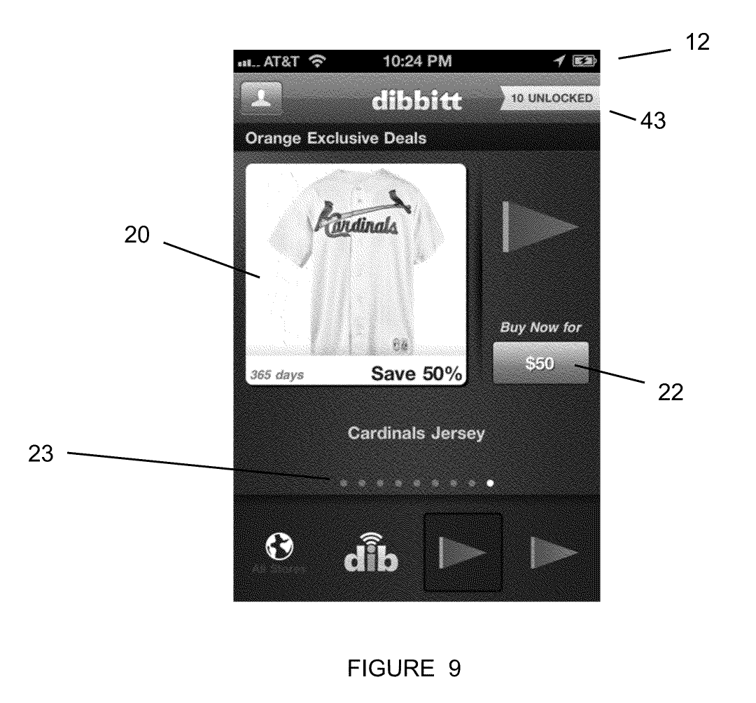

As discussed above, offer 20 can be for goods and/or services tailored to the event and/or the event's location. FIG. 9 shows such an offer 20, for goods specific to an event and/or location—that is, a Cardinals jersey specific to a Cardinals sports event that is occurring within geo-fence 10.

As with the mobile device screen shown in FIG. 5, in FIG. 9 offers 20 tailored to the event and/or the event's location are delivered to mobile device 12 by server 15, or another server associated with the system. Multiple offers 20 specific to the event and/or location can be presented to the user, not just the single offer 20 shown in FIG. 9. Moreover, offers 20 specific to multiple events and/or multiple locations can be presented to the user—in other words, not just offers specific to a single event. In the scenario with multiple offers 20, the user can page through the other offers by any suitable method, for example by “swiping” at the screen of mobile device 12 to move the currently-displayed offer from the screen and display a different offer. Pagination dots 23 are displayed on the screen below the offers 20, to indicate where the currently-displayed is among the multiple offers and aid the user in navigating among multiple offers.

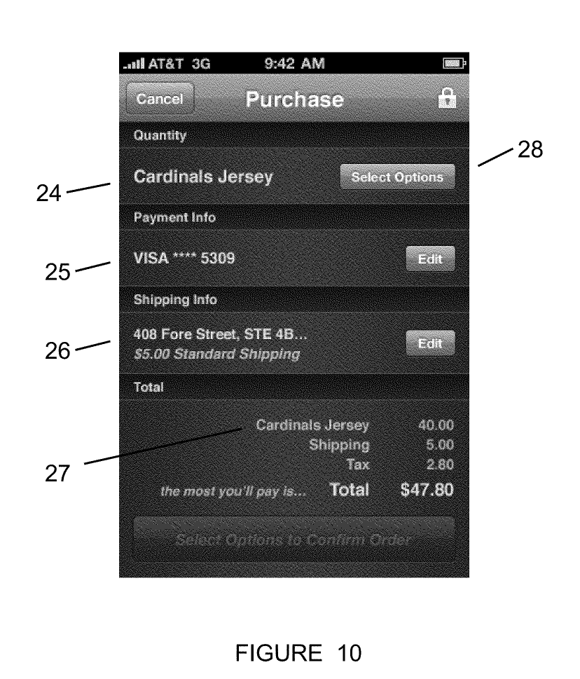

When the user taps on Buy Now button 22 in FIG. 9, the purchase screen shown in FIG. 10 appears. In this screen, the system displays the selected item for purchase 24; payment information 25 such as the default credit card to be used for the purchase; shipping information 26 such as the default address to which the item will be shipped; and the item cost 27. The user can change payment information 26 and shipping information 27 by tapping on the respective Edit buttons shown.

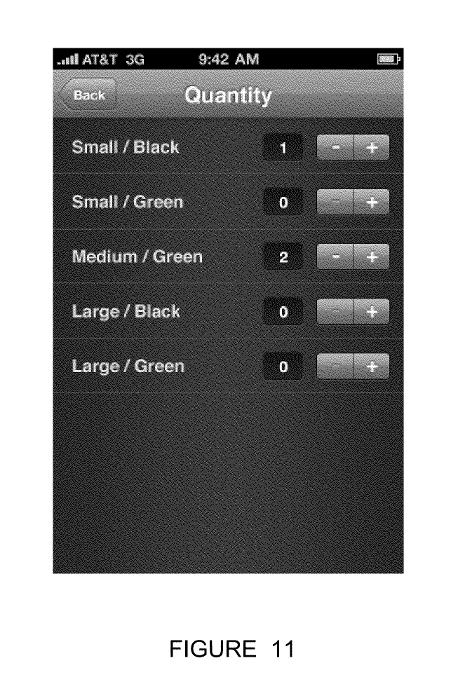

Depending on the nature of item for purchase 24, there may be various options associated with said item. There are such options for the Cardinals jersey, as indicated by Select Options button 28. When the user taps on Select Options button 28, the quantity screen shown in FIG. 11 appears. Using this screen, the user can edit the order quantities for various versions (such as different colors, sizes, etc.) that are available for item for purchase 24. It can be appreciated that other items for purchase 24 may have different options and available versions.

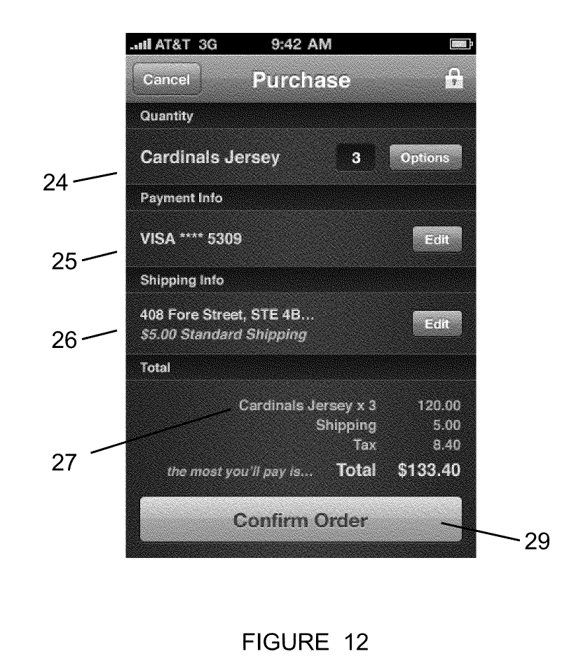

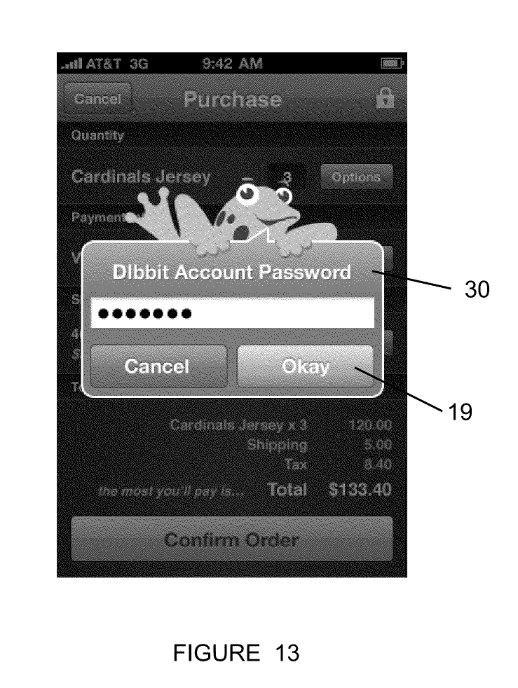

After the user has designated any options that are available for item for purchase 24, the system returns the user to the screen shown in FIG. 12. The user reviews his order, and if it is satisfactory, the user confirms his order by tapping on Confirm Order button 29. The password alert 30 shown in FIG. 13 appears, and the user is required to enter the password associated with his user account on the system. After the user enters the correct password for his user account and taps on Okay button 19, the system then processes the order for shipment.

If there are no options for the particular item for purchase 24, and the system requires no further information to complete the order, the user is directed to confirm the order by tapping a Confirm Order button displayed directly on a purchase screen similar to those shown in FIGS. 10 and 12.

After an online store has been unlocked (i.e., access-enabled) for a particular user—for example, by the user being within the geo-fence for an event—the online store stays unlocked for that user when the event occurs again in the future—no matter where the user is located when the event occurs again. As just one example, if the user attends a concert in Boston by a certain musical artist on one date and thus unlocks the online store associated with that artist, the online store is available to that user when the musical artist has a future concert in Los Angeles far from the physical location of the user. Similarly, if the user attends a Boston Red Sox game when he happens to be in Boston and thus unlocks the online store associated with Red Sox games, the online store is available to that user when another Red Sox game occurs even though the user may be in Florida at that future time, far from the physical location of the event.

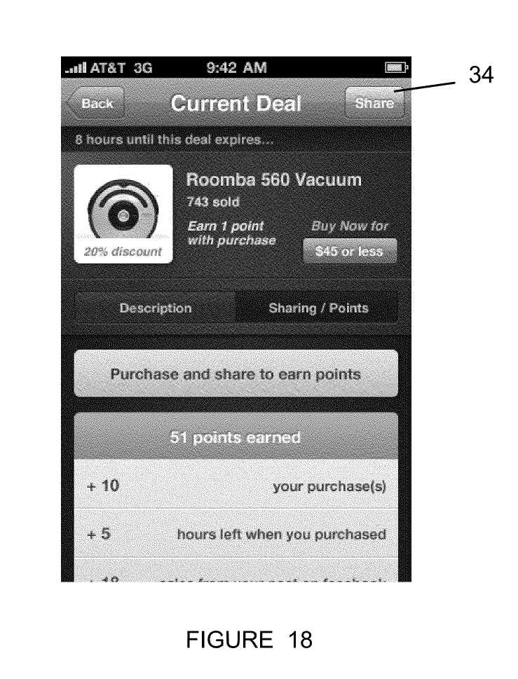

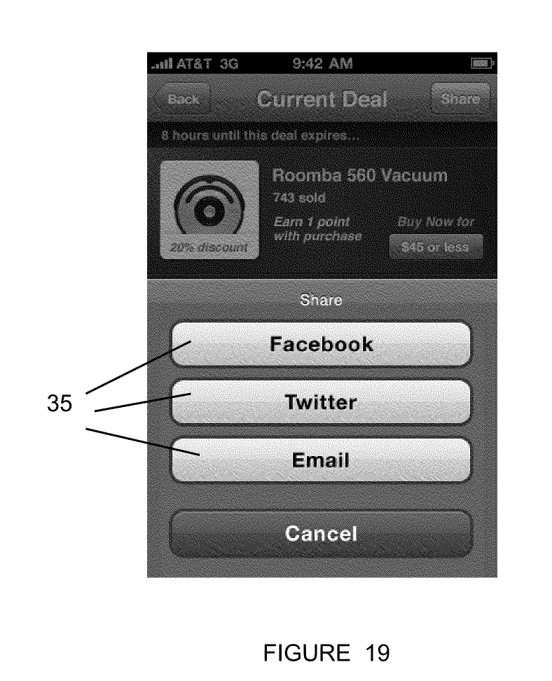

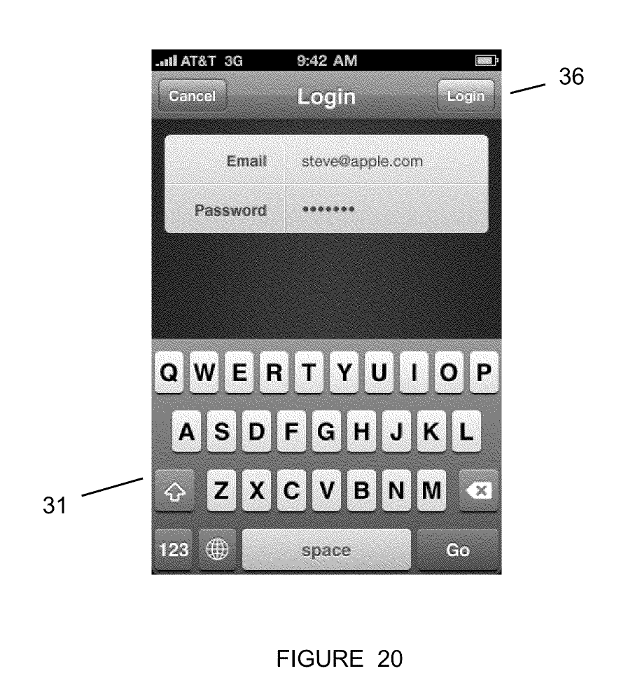

In addition, when a user is accessing an online store and sees an attractive offer, he can share that offer with other users of the system by tapping a share button 34 like that shown in FIG. 18. After tapping share button 34, the user is taken to the screen shown in FIG. 19, where various share methods 35 are presented to him. The user chooses a share method by tapping on the button associated with that share method. If the share service operating that share method requires a web-view, log-in, or other special procedure to identify the user before posting the shared information, the screen shown in FIG. 20 is presented to the user.

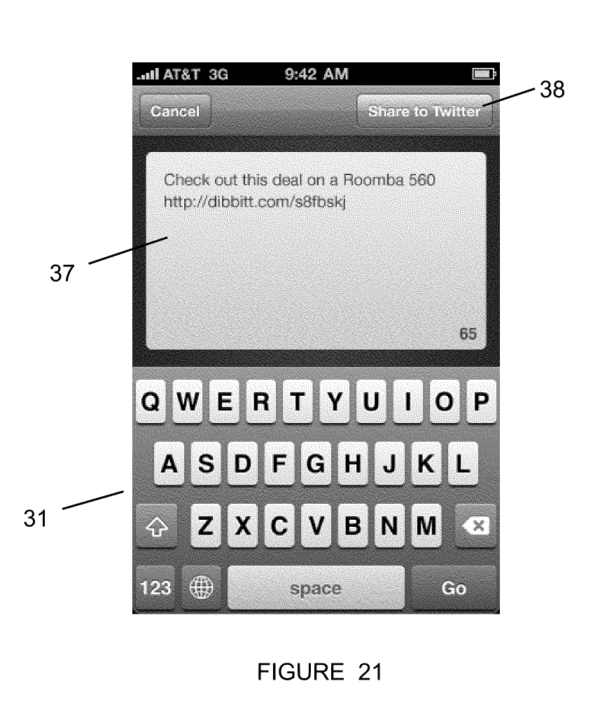

After the user inputs the appropriate user identification via keypad 31 and taps Login button 36, or if no user identification is required, the screen shown in FIG. 21 appears. The system can pre-populate a share text display area 37 with text that promotes the offer, for example with an Internet link to the offer, and the user can also use keypad 31 to type his own share text into share text display area 37. After the share text is entered, the user taps on Share to (share service) button 38, and the system coordinates with the share service to communicate the offer to other users.

### Administration Aspect of System and Method

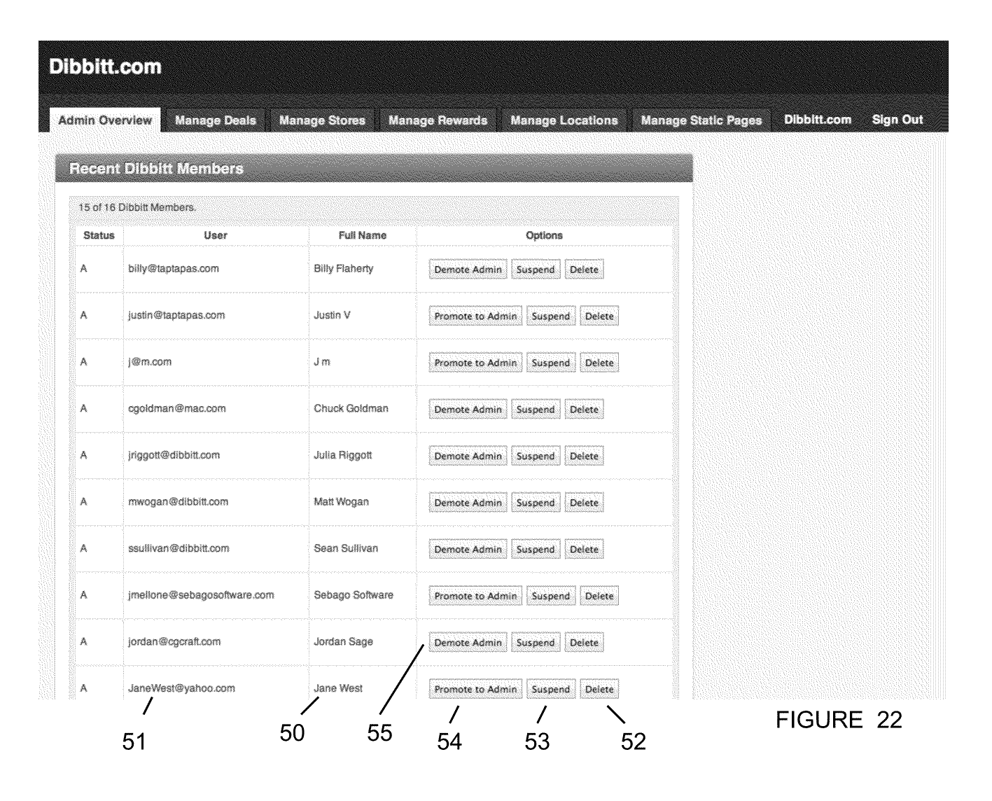

An administration aspect is also included in the inventive system and method, to manage various aspects of the system including the users who subscribe to the system, the offers/deals that the system presents to the users, the online stores associated with the offers, the locations associated with the online stores and the offers, and other rewards that the system provides to the users. The administrator accesses a particular element of the system (Manage deals, Manage Stores, etc.) by clicking on the tabs located on the screens shown in FIGS. 22 to 30 and discussed below. The administration system and method runs on any suitable server or other computer, and can be accessed through either an Internet website or other suitable means.

FIG. 22 shows the screen in the administration system and method that displays the various User names 50 and associated User email addresses 51. The administrator can delete a particular user by clicking on Delete button 52, or suspend a user's ability to interact with the system by clicking on Suspend button 53. The administrator can also give certain administrative privileges to a particular user by clicking on Promote to admin button 54, and can conversely revoke the administrative privileges of a user by clicking on Demote admin button 55.

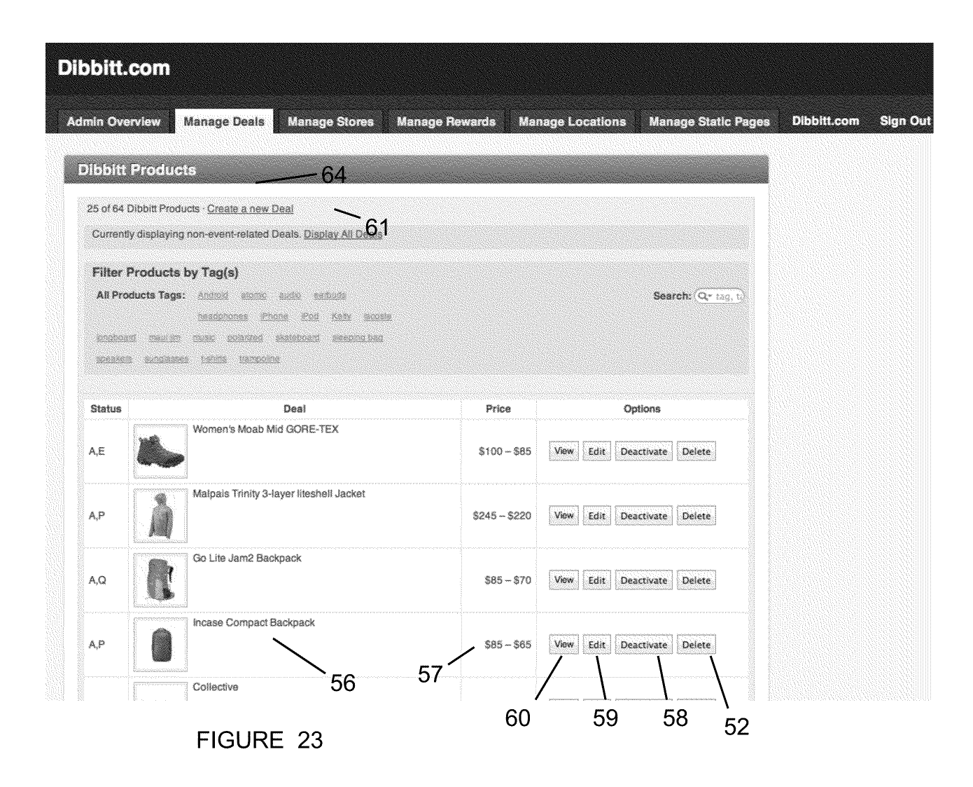

FIG. 23 shows the screen in the administration system and method that displays the various offers/deals present in the system. The Offer name 56 and the Offer price 57 are shown for each offer. The administrator can add an offer to the system by clicking on Create a new deal button 64, and then filling in the details associated with the new offer. The administrator can also delete a particular offer by clicking on delete button 52; deactivate the offer (i.e., disable it without permanently deleting it) by clicking on Deactivate button 58; change various elements of the offer by clicking on Edit button 59; or display the detail on a particular offer by clicking on View button 60. It should be understood that while the screen shown in FIG. 23 displays non-event-related offers, this is just an example, and the administrator can display all offers in the system including event-related offers by clicking on Display all deals button 61.

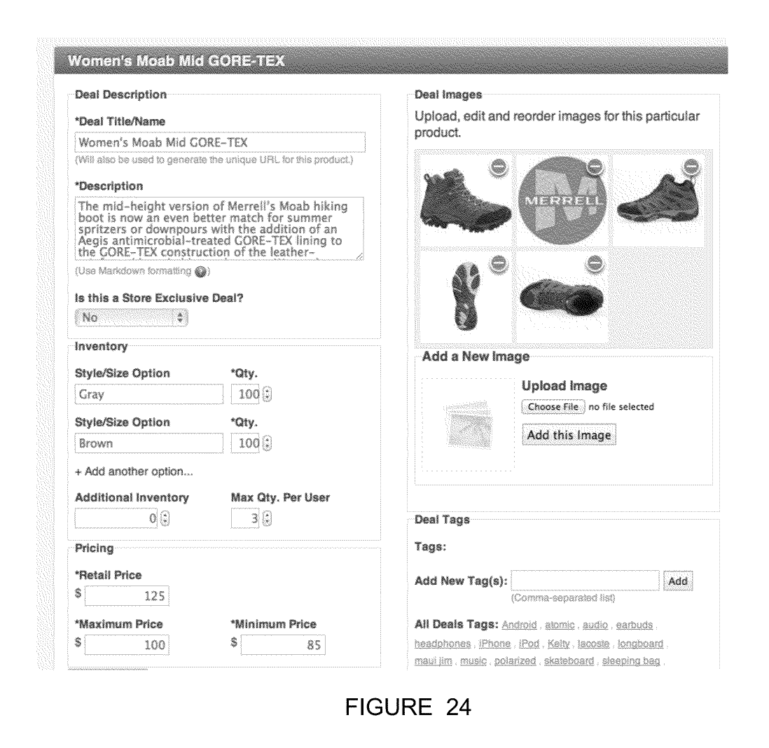

When the administrator clicks on Edit button 59 in FIG. 23, the screen shown in FIG. 24 appears. This screen provides detailed information about the item being offered, which the administrator can change if desired.

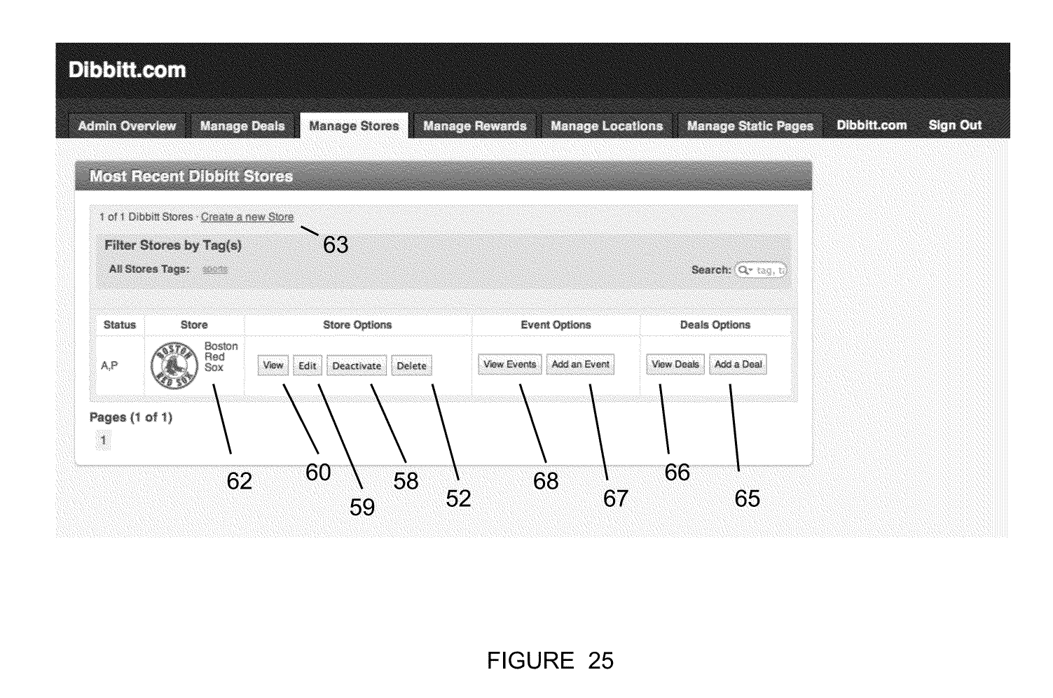

FIG. 25 shows the screen in the administration system and method that displays the various online stores present in the system. The Online store name 62 is shown for each online store. The administrator can add a store to the system by clicking on Create a new store button 63, and then filling in the details associated with the new store. The administrator can also delete a particular store by clicking on delete button 52; deactivate the store (i.e., disable it without permanently deleting it) by clicking on Deactivate button 58; change various elements of the store by clicking on Edit button 59; or display the detail of a particular store by clicking on View button 60.

As discussed above, the system associates various events with online stores—i.e., sports contests, concerts, and many other types of performances the occurrence of which triggers the establishment of a geo-fence and potential access to the online store. The system also associates various offers of goods and/or services with the online store. The administrator can view the offers associated with a store by clicking on View deals button 66, or add an offer to a store by clicking on Add a deal button 65. The administrator can also view the events associated with a store by clicking on View deals button 68, or add an event to a store by clicking on Add an event button 65.

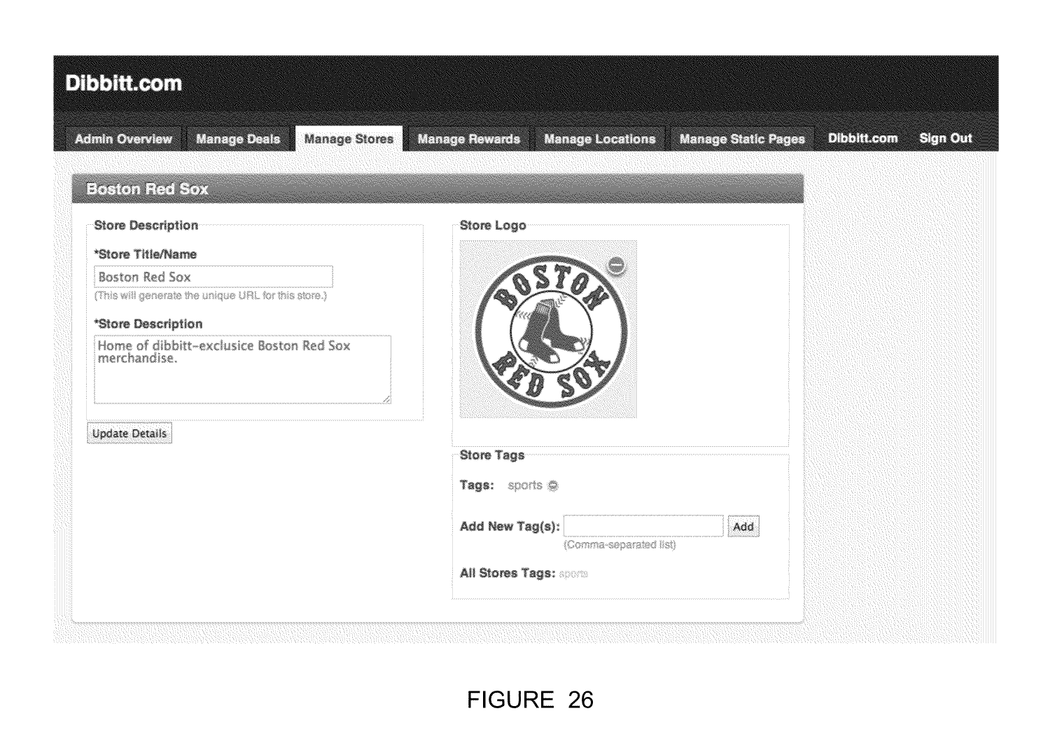

When the administrator clicks on Edit button 59 in the FIG. 25 screen, the screen shown in FIG. 26 appears. This screen provides detailed information about the online store, which the administrator can change if desired.

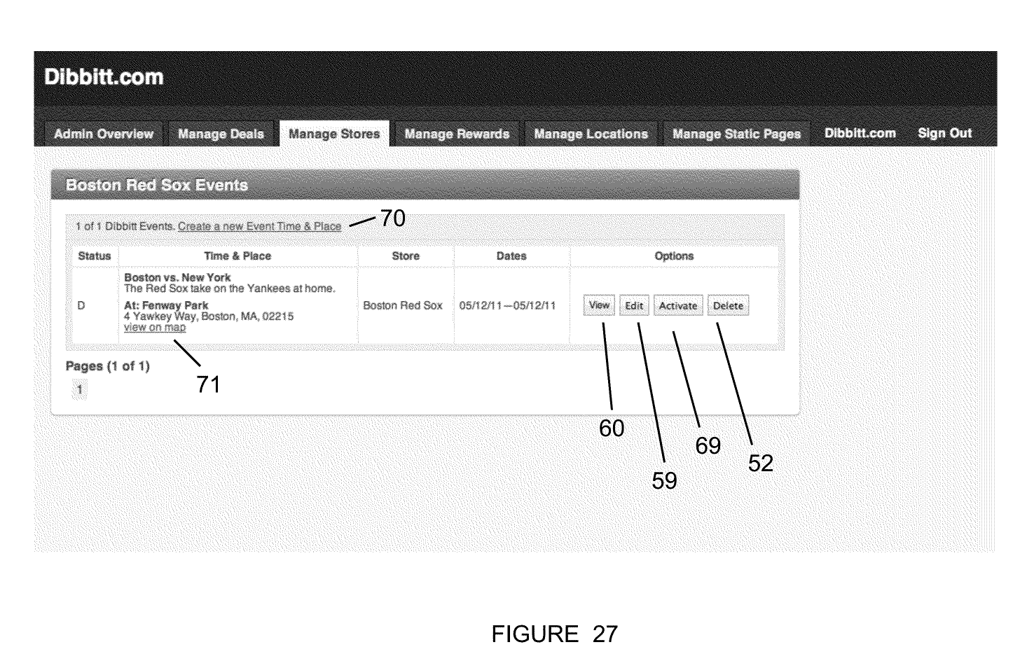

When the administrator clicks on View events button 68 in the FIG. 25 screen, the screen shown in FIG. 27 appears. This screen provides detailed information about the events associated with a particular online store. The name, time, and location of the event are shown, as well as the online store with which the event is associated, and the beginning and ending date of the event. The administrator can also see where the event location is, with respect to other things, by clicking on View on map button 71. The administrator can add a store to the system by clicking on Create a new event button 70, and then filling in the details associated with the new event. The administrator can also delete a particular event by clicking on Delete button 52; activate the event if it is currently deactivated (i.e., enable the establishment of a geo-fence and online store access while the event occurs) by clicking on Activate button 69; change various elements of the event by clicking on Edit button 59; or display the detail of a particular event by clicking on View button 60. It should be understood that if the event is currently activated, this screen will include a Deactivate button similar to that shown in FIG. 25, and the administrator can deactivate the event by clicking on the Deactivate button.

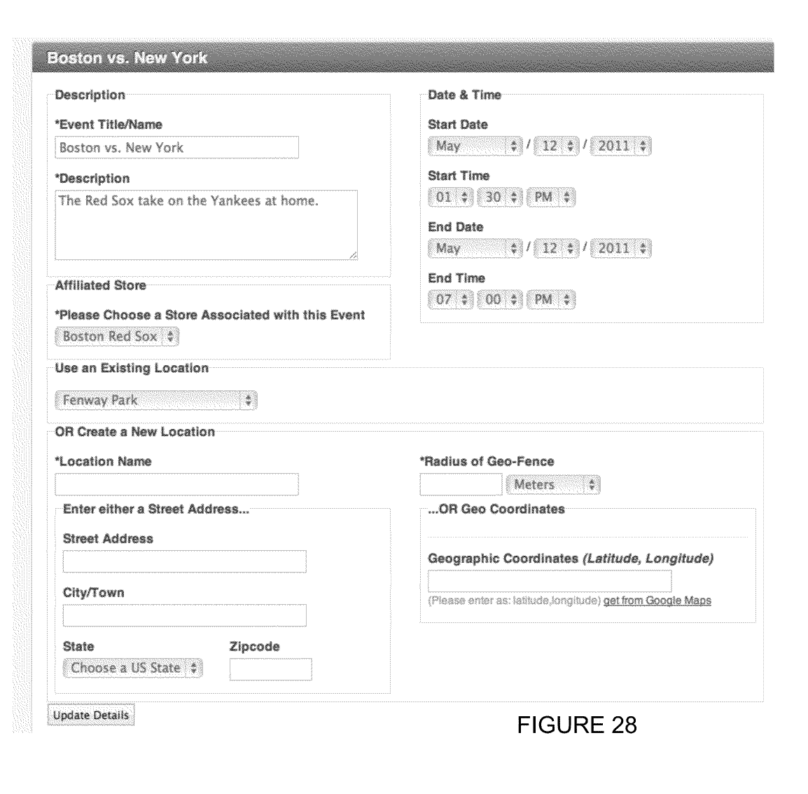

When the administrator clicks on Edit button 59 in the FIG. 27 screen, the screen shown in FIG. 28 appears. This screen provides detailed information about the event which the administrator can change if desired, including the geographic location associated with the event. The administrator can also create a new location for the event from this screen, including particulars about the geo-fence to be established around the event.

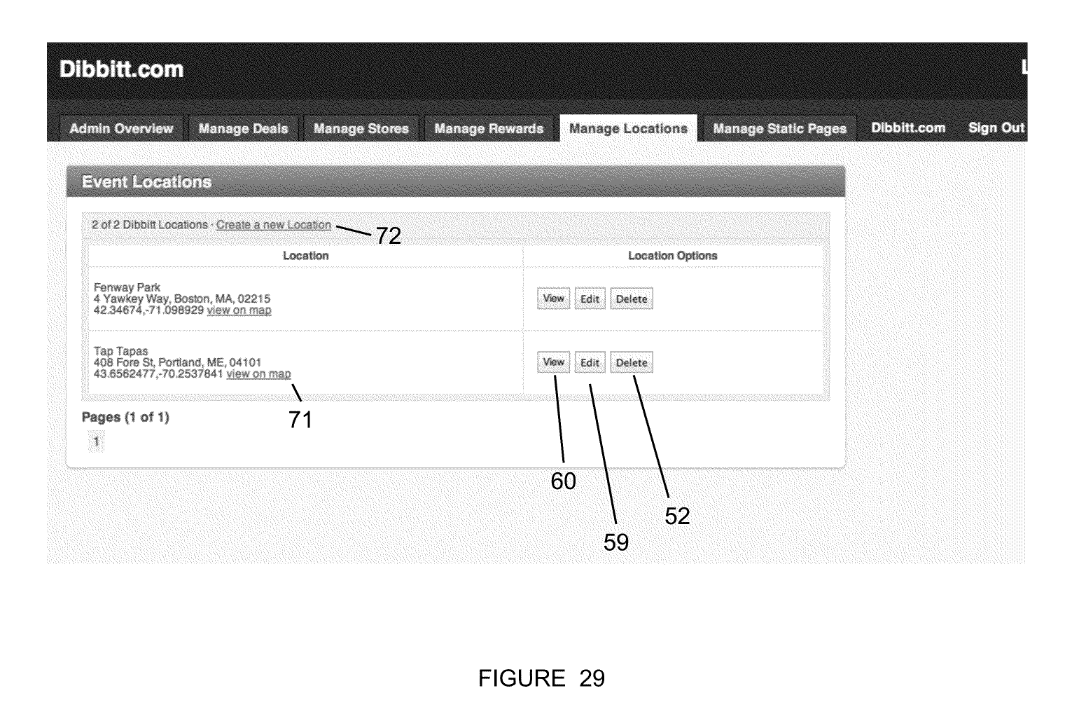

FIG. 29 shows the screen in the administration system and method that displays the various geographic locations present in the system which can be associated with an event. The location name, address, and coordinates are shown for each online store, and the administrator can also see where the location is with respect to other things by clicking on View on map button 71. The administrator can add a location to the system by clicking on Create a new location button 72, and then filling in the details associated with the new location. The administrator can also delete a particular location by clicking on Delete button 52; change various elements of the location by clicking on Edit button 59; or display the detail of a particular location by clicking on View button 60.

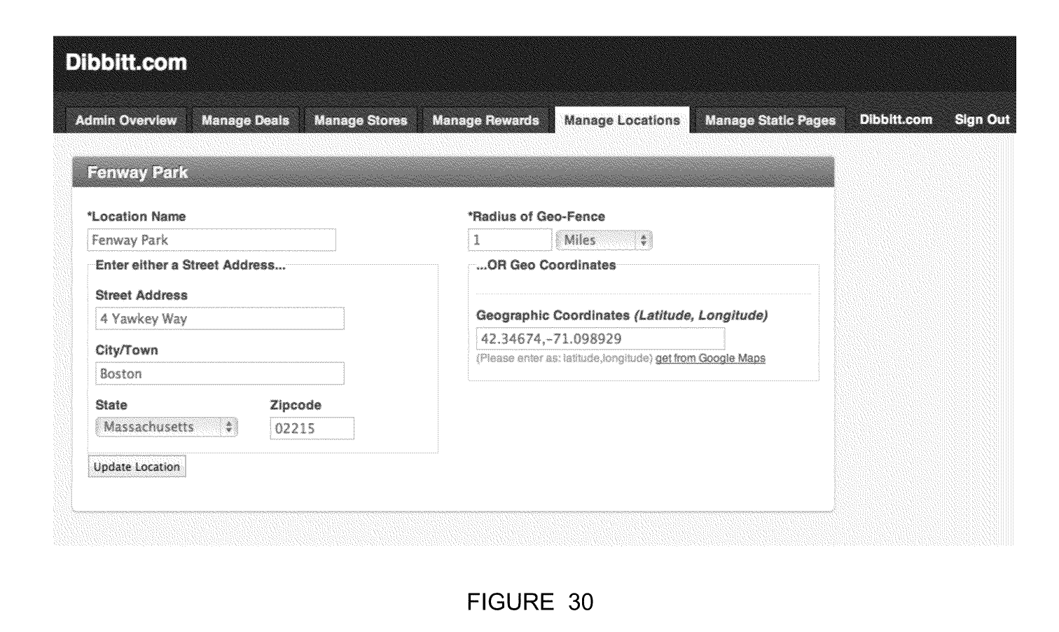

When the administrator clicks on Edit button 59 in the FIG. 29 screen, the screen shown in FIG. 30 appears. This screen provides detailed information about the location which the administrator can change if desired, including particulars about the geographic coordinates of the location and the geo-fence to be established around the location.

While the above descriptions contain many specificities, these shall not be construed as limitations on the scope of the invention, but rather as exemplifications of embodiments thereof. Many other variations are possible without departing from the spirit of the invention.

Accordingly, the scope of the invention should be determined not by the embodiments illustrated, but by the appended claims and their legal equivalents.

What is claimed is:

1. A method for location and event-based mobile commerce, comprising the steps of:
establishing, by a computer, a geo-fence around an event;
providing access to an online store, to a user of a portable communications device that is within or comes within said geo-fence while said event is occurring;
wherein said user utilizes said portable communications device to purchase goods or services associated with said event and offered in said online store; and
wherein said event is not itself the offer of said goods or services.

2. The method of claim 1, wherein said event is a sports contest.

3. The method of claim 1, wherein said event is a musical performance.

4. The method of claim 1, wherein after being initially provided with access to said online store, said user can access said online store at a later time, when said user's portable communications device is no longer within said geo-fence or said event is no longer occurring.

5. The method of claim 1, wherein determining a location of said portable communications device is done by triangulating transmissions between said portable communications device and a plurality of other transmitters.

6. The method of claim 1, wherein determining a location of said portable communications device is done by a global positioning system receiver located in said portable communications device.

7. The method of claim 1, wherein said portable communications device is an Internet-enabled cellular telephone.

8. The method of claim 1, wherein said goods or services offered in said online store are tailored based on past sales of said goods or services or other goods or services, a characteristic of said event, or a characteristic of a performer at said event.

9. The method of claim 1, wherein said goods or services offered in said online store are tailored based on a physical location of said event.

10. The method of claim 1, wherein said user shares a goods or services offer from said online store with another user.

11. A system for location and event-based mobile commerce, comprising:
a computer adapted to establish a geo-fence around an event;
a server adapted to provide access to an online store associated with said event;
a portable communications device adapted to access said online store when said portable communications device is within or comes within said geo-fence while said event is occurring;
wherein a user can utilize said portable communications device to purchase goods or services offered in said online store; and
wherein said event is not itself the offer of said goods or services.

12. The system of claim 11, wherein said event is a sports contest.

13. The system of claim 11, wherein said event is a musical performance.

14. The system of claim 11, wherein after initially accessing said online store, said user can access said online store at a later time when said portable communications device is no longer within said geo-fence or said event is no longer occurring.

15. The system of claim 11, wherein determining a location of said portable communications device is done by triangulating transmissions between said portable communications device and a plurality of other transmitters.

16. The system of claim 11, wherein determining a location of said portable communications device is done by a global positioning system receiver located in said portable communications device.

17. The system of claim 11, wherein said portable communications device is an Internet-enabled cellular telephone.

18. The system of claim 11, wherein said goods or services offered in said online store are tailored based on past sales of said goods or services or other goods or services, a characteristic of said event, or a characteristic of a performer at said event.

19. The system of claim 11, wherein said goods or services offered in said online store are tailored based on a physical location of said event.

20. The system of claim 11, wherein said user shares a goods or services offer from said online store with another user.
